(19) United States
(12) Patent Application Publication
(10) Pub. No.: US 2026/0197603 A1
(43) Pub. Date: Jul. 9, 2026

(54) LOW POWER CONSUMPTION FOR HAZARD DETECTION BY MOBILE DEVICES

(71) Applicant: Google LLC, Mountain View, CA (US)

(72) Inventors: Mei LU, Los Altos, CA (US); Xuemei OUYANG, Redwood City, CA (US); Oliver Alexander WARFIELD, Brooklyn, NY (US); Junfeng PAN, Shanghai (CN); Chunlei ZHU, Shanghai (CN); BoRuei KAO, Taipei (TW); Yu-Sung LEE, Taoyuan (TW); Xinyi ZHANG, Taipei (TW)

(73) Assignee: Google LLC, Mountain View, CA (US)

(21) Appl. No.: 19/009,747

(22) Filed: Jan. 3, 2025

(51) Int. Cl. H04W 4/024; G06V 20/50; G06V 40/18; G08B 21/02; H04N 23/667

(52) U.S. Cl. CPC H04W 4/024; G08B 21/02; G06V 20/50; G06V 40/18; H04N 23/667

(57) ABSTRACT

Implementations relate to low power consumption for hazard detection by mobile devices. In some implementations, a computer-implemented method includes obtaining sensor data from sensors of a device, including global positioning sensor data indicating geographical locations of the device. Map data is obtained that describes features of a geographical area in which the device is located. Based on the sensor data, map data, and the geographic locations, it is determined whether one or more potential hazards are within a threshold distance of the device. If so, a rear camera of the device is activated, images are captured using the rear camera, and it is determined whether hazard objects are positioned within a particular distance of the device based on the captured images. An alert is output by the processor in response to determining that hazard object(s) are within the particular distance of the device.

### BACKGROUND

Users of mobile electronic devices, including smartphones, use their devices in many different environments and locations. Many users operate their devices while moving by foot, such as when walking, jogging, etc. However, when moving by foot, a user may focus their attention on the device display and may have insufficient attention to their surroundings, causing the user to, on occasion, fail to notice objects in their path. This can sometimes result in the user encountering a hazard, such as colliding with an object in their path or falling from a curb or ledge, which can cause injury in some cases.

Many mobile electronic devices include cameras that capture images. Some devices may capture images with the camera and alert the user if an object is detected in captured images. However, powering the camera of the device continuously to capture images during user travel can consume significant amounts of power, which may be of concern in portable devices that have limited battery life.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to low power consumption for hazard detection by mobile devices. In some implementations, a computer-implemented method includes obtaining, by at least one processor, sensor data from one or more sensors of a device, the sensor data including global positioning sensor data. The method includes determining, by the processor based on the sensor data, geographic locations of the device, obtaining map data that describes features of a geographical area in which the device is located, and determining, by the processor based on the map data and the geographic locations of the device, whether one or more potential hazards are within a threshold distance of the device. In response to determining that the one or more potential hazards are within the threshold distance to the device, the method includes activating, by the processor, a rear camera of the device, capturing images using the activated rear camera of the device, and determining, by the processor, whether one or more hazard objects are positioned within a particular distance of the device based on the images captured by the rear camera. An alert is output by the processor in response to determining that the one or more hazard objects are within the particular distance of the device.

Various implementations of the device are described. For example, in some implementations, the threshold distance is based on an accuracy of the global positioning sensor data in determining the geographical locations of the device. In some implementations, the threshold distance is based on one or more characteristics of an environment in which the device is located. In some implementations, the method further includes determining by the processor, based on the sensor data, a projected path of the device through a geographical region, and determining, by the processor based on the map data and the geographic locations of the device, whether the one or more potential hazards are within a threshold angular range of the projected path, wherein activating the rear camera of the device is performed in response to determining that the one or more potential hazards are within the threshold distance to the device and within the threshold angular range of the projected path of the device.

In some implementations, in response to determining that the one or more potential hazards are not within the threshold distance to the device, the method further includes omitting the activating of the rear camera of the device at a current geographical location of the mobile device; obtaining additional sensor data that describes an updated geographical location of the device; determining, by the processor based on the map data and at least the additional sensor data, whether at least one potential hazard is within the threshold distance of the device; and in response to determining that the at least one potential hazard is within the threshold distance to the device, performing the activating the rear camera of the device, the capturing the images, the determining whether one or more hazard objects are positioned within the particular distance of the device, and the outputting the alert.

In some implementations, the method further includes determining, by the processor based on the sensor data, a projected path of the device through a geographical region, and determining, by the processor, whether the one or more hazard objects are positioned within a particular angular range of the projected path of the device. In some implementations, the method further includes causing the images captured by the rear camera to be displayed on a display screen of the device and causing highlighting of the one or more hazard objects in the displayed images.

In some implementations, the method further comprises determining, by the processor based at least on the sensor data, whether the device is being moved by a user using foot locomotion, and obtaining the map data and determining that the potential hazards are within the threshold distance is performed in response to determining that the device is being moved by the user using foot locomotion. In some implementations, the sensor data includes motion data sensed by at least one motion sensor of the device, and determining whether the device is being moved by the user using foot locomotion includes determining, based on the motion data, whether the device is being moved by the user via foot locomotion, and determining, based on the global positioning sensor data, whether the device is being moved at less than a threshold velocity that indicates the foot locomotion. In some implementations, in response to determining that the device is not being moved by the user using foot locomotion, activating of the rear camera of the device is omitted.

In some implementations, the sensor data includes motion data sensed by at least one motion sensor of the device, and the method further includes determining, by the processor based on the motion data, whether an orientation of the device is within a threshold angular range corresponding to a viewing orientation of the device for a user, and obtaining the map data and determining that the one or more potential hazards are within the threshold distance to the device is performed in response to determining that the orientation of the device is within the threshold angular range. In some implementations, the method further comprises activating a front camera of the device by the processor, and detecting, by the processor, features in one or more images captured by the activated front camera to determine whether a user's gaze is directed to a display screen of the device, wherein obtaining the map data and determining that the one or more potential hazards are within the threshold distance to the device is performed in response to determining that the user's gaze is directed to the display screen. In some implementations, the method further includes determining, by the processor, whether a battery level of the device is above a threshold power level, and activating the front camera is performed in response to determining that the battery level is above the threshold power level.

In some implementations, a mobile device includes at least one processor, one or more global positioning sensors coupled to the at least one processor, wherein the one or more global positioning sensors are operative to provide global positioning sensor data to the at least one processor, and a rear camera coupled to the at least one processor. The processor is configured to perform operations including operations similar to the method described above.

In some implementations, a non-transitory computer-readable medium has instructions stored thereon that, when executed by a processor, cause the processor to perform operations including operations similar to the method and/or mobile device described above.

### BRIEF DESCRIPTION OF THE DRAWINGS

FIG. 1 is a diagrammatic illustration of a walking user of a device and potential hazards in a path of the walking user, according to some implementations;

FIG. 2 is a flow diagram illustrating an example method to perform hazard detection with low power consumption, according to some implementations;

FIG. 3 is a diagrammatic illustration of an example map of features around a user that can be used to detect potential hazards in the user's path;

FIG. 4 is a diagrammatic illustration of an example device and displayed view of an image captured by a rear camera of the device, according to some implementations; and

FIG. 5 is a block diagram of an example device which may be used to implement one or more features described herein.

### DETAILED DESCRIPTION

This disclosure relates to low power consumption hazard detection by mobile devices. In some implementations, a device obtains sensor data that indicates a location of the device and map data that indicates geographical features in an area in which the device is located. Based on the device location and map data, the device determines whether potential hazards are within a threshold distance of the device and/or within a threshold angular range of a projected path of the device. If these conditions are detected, a rear camera of the device is activated, images are captured with the rear camera, and it is determined from the captured images whether potentially hazardous objects are present, e.g., are positioned in the path of the user. An alert is output in response to detecting such hazardous objects in the captured images. The rear camera is not activated if no potential hazards are detected.

Various additional features are also described. In some implementations, device sensor data is used to determine whether the device is being moved by a user using foot locomotion. In some implementations, device sensor data is used to determine whether a current orientation of the device corresponds to a viewing angle to indicate the user is viewing the device while walking. In some implementations, a front camera of the device is used to determine if user eye gaze is at the display screen of the device. If these conditions are not present, map data operations, rear camera operations, and/or alerts can be omitted.

Described features advantageously provide techniques that enable detection of hazards in a walking user's path with low power consumption, achieved through selective activation of the device camera. The device can determine if potential hazards are present using location data and map data and can avoid powering on the rear camera of the device if no potential hazards are detected near to the device. These features can reduce power consumption on a mobile device in which battery power is limited, yet also use the rear camera when appropriate to provide greater accuracy or certainty in detection of potentially hazardous objects that are close to the user. Other device conditions can also be detected to determine whether to obtain and examine map data and/or whether to activate the rear camera, such as detecting device motion, detecting whether that motion is due to a user walking, determining whether the device is oriented for viewing by the user, and/or determining whether the user's eye gaze is focused on the device while walking. These conditions can be used to determine whether to activate the rear camera of the device, e.g., to determine whether potentially hazardous conditions are present for a user. If those conditions are detected to be absent, wasteful power consumption for powering the rear camera is avoided.

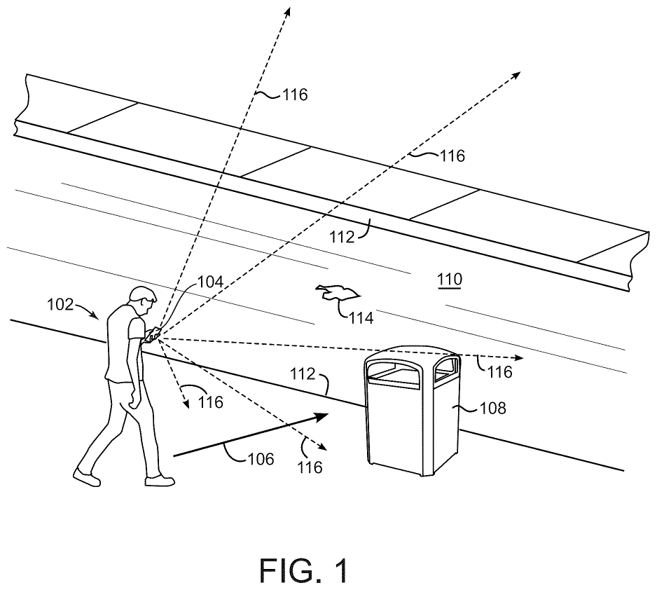

FIG. 1 illustrates an example of a user using a mobile device while walking along a path that may include potential hazards to the user. In this example, a user 102 is looking down at and concentrating on a mobile device 104 held in the user's hand while the user is walking. Since the user is looking mostly downward toward the device and the user is concentrating on the contents displayed on the display screen of the device, the user's attention is reduced for the user's walking environment.

The user walks along a path 106, which may bring the user close to one or more potential hazards that could cause the user to experience hardship or injury. For example, the path 106 may bring the user near to large objects such as a trash can 108, a bench, a signpost, a support pillar etc. In some cases, the user's path may approach a larger object such as a wall, fence, tree, or building. Since the user is concentrating on device 104, the user could collide with one of these objects, which could cause the user to receive injury and/or to fall onto the ground. In other cases, the user 102 may have impaired vision, and may be unable to see many potential hazards in the path 106 even if the user is not concentrating on the device.

Potential hazards in path 106 of user 102 can also include a street 110 that may direct other objects, such as vehicles or other persons, to move in a path that crosses the user's path. In addition, curbs 112 to the street may be a hazard, where the ground on which the user is walking has a sudden drop or rise in elevation. Similarly, a pothole 114 or other hazardous objects may be present in the street or other areas in or near path 106 of the user.

In various implementations of the techniques described herein, device 104 can be used to detect conditions related to the user's walking activity and can warn the user of potential hazards in the user's path 106. In some implementations, multiple conditions can be detected that indicate with a high confidence that the user is approaching one or more potential hazards. In some cases, when particular conditions (e.g., preconditions) are detected, the rear camera of the device 104 (pointing away from the user operating the device) is activated and captures images of a scene in front of the user. The device can detect objects in the captured images and, if an object is determined to be potentially hazardous to the user, alert the user to the presence of the object, as described in various implementations herein. In this example, the scene captured in the rear camera images is indicated by arrows 116.

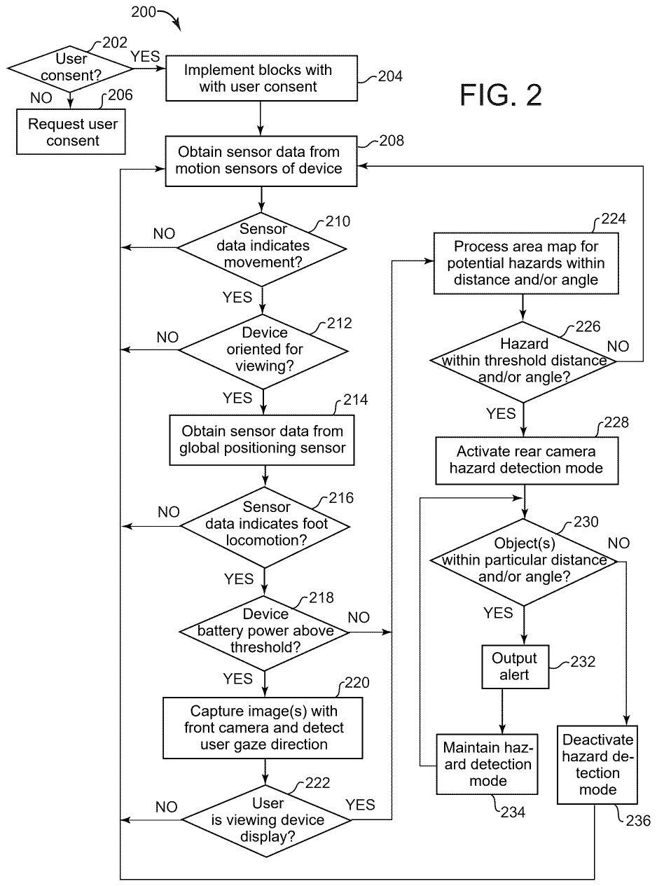

FIG. 2 is a flow diagram illustrating an example method 200 to perform hazard detection with low power consumption, according to some implementations. In some implementations, method 200 can be performed, for example, by a mobile device, e.g., device 104 as shown in FIG. 1. In some implementations, method 200, or portions thereof, can be performed on server device(s), or can be performed on server device(s) and client device(s). In described examples, the implementing device includes one or more digital processors or processing circuitry (“processors”), and can include one or more storage devices (e.g., memory or other storage), examples of which are described below.

Implementations discussed herein do not require collection or usage of user personal information. For example, user location, user depiction in captured images, and other sensor data captured on a client device can be processed by method 200 at the client device without collection or usage or storage of user personal information, and without transmission of images or other user data to server systems. In situations in which certain implementations discussed herein may collect or use personal information about users, users are provided with one or more opportunities to control whether information is collected, whether the personal information is stored, whether the personal information is used, and how the information is collected about the user, stored and used. That is, the systems and methods discussed herein collect, store and/or use user personal information specifically upon receiving explicit authorization from the relevant users to do so. Each user for which personal information is to be collected is presented with one or more options to allow control over the information collection relevant to that user, to provide permission or authorization as to whether the information is collected and as to which portions of the information are to be collected. In addition, certain data may be treated in one or more ways before it is stored or used so that personally identifiable information is removed. As one example, a user's identity may be treated so that no personally identifiable information can be determined. As another example, a user's geographic location may be generalized to a larger region so that the user's particular location cannot be determined.

In some implementations, the method 200, or portions of the method, can be initiated automatically by a device. For example, the method (or portions thereof) can be performed continuously or periodically, e.g., at other suitable intervals. In some implementations, the method (or portions thereof) can be performed based on one or more particular events or conditions, e.g., reception of particular user input, detection of a particular type of location to which the user has moved, a predetermined time period having expired since the last performance of method 200, and/or one or more other conditions occurring which can be specified in settings read by the method. Method 200 may begin at block 202.

In block 202, it is determined whether user permission has been obtained to use user data in the implementation of method 200. For example, user data for which permission is obtained can include geographic locations visited by the user, images captured of and by the user, user data related to the use of applications of the device, etc. The user is provided with options to selectively provide permission to access and determine such user data. For example, a user may choose to provide permission to access all of the requested user data, any subset of the requested data, or none of the requested data. One or more blocks of the methods described herein may use such user data in some implementations.

If it is determined in block 202 that permissions provided by the user are sufficient, block 202 is followed by block 204, else block 202 is followed by block 206.

In block 204, it is determined that the remainder of method 200 (blocks 208-236) as described herein can be implemented with the user-provided permissions, e.g., by selectively accessing data as permitted by the user. In some implementations, the user may be provided additional prompts to provide access to user data or to modify permissions. Block 204 may be followed by block 208.

In block 206, user permission is requested to access user data. For example, if the user has denied permission for one or more portions of user data that may be used in blocks 208-236, a user interface may be provided for the user to provide permission for such portions of the user data. The user interface may indicate to the user how the data may be used and/or provide an indication that providing such permissions may benefit the user, e.g., by enabling low power consumption for hazard detection. The process may then return to block 202. If the permission provided by the user is sufficient, block 202 is followed by block 204 as described above. Alternatively, e.g., if the user dismisses the request for access to user data or otherwise indicates their denial of permission, the method ends at block 206, such that no user data is accessed. In such a case, blocks 208-236 are not performed.

In block 208, sensor data is obtained by the device. The obtained sensor data can include motion data from one or more motion sensors, e.g., sensor data from one or more accelerometers and/or one or more gyroscopes of the device. The sensor data can include data from a magnetometer of the device. For example, sensor data output by an inertial measurement unit (IMU) of the device can be obtained, which can measure acceleration, angular rate, orientation, gravitational forces, etc. and thus can sense motion of the device 104 or 400, e.g., when it is picked up by a person, taken out of a pocket, carried while a person is moving, etc. Block 208 may be followed by block 210.

In block 210, it is determined whether the sensor data obtained in block 208 indicates movement of the device and movement of a user carrying the device. For example, accelerometer data and gyroscope data from the motion sensors can indicate whether the device is moving and/or whether the device is being carried by a person, e.g., based on vibration and other sensed motion. If the sensor data indicates such movement, the method continues to block 212, else the method continues to block 208 to obtain additional sensor data.

In block 212, it is determined whether the device is oriented at a viewing orientation for viewing by a user. In some examples, such a viewing orientation can be a tilt of the device in a particular range relative to the ground that indicates it is being held by a user who is viewing and operating the device. For example, the viewing orientation can be a range of 30-90 degrees from the horizontal ground orientation, or other angle range. In some implementations, e.g., users who may have impaired vision, the device can be in an approximately vertical orientation (e.g., 90 degrees from horizontal), e.g., if the device is being carried by a lanyard, strap, necklace, or other carrying accessory on the user to allow it to face forward to detect objects.

If the sensor data indicates the device is held at the viewing orientation, then there is greater likelihood that the user may be viewing the device and may be distracted from their environment, and the method continues to block 214. Otherwise, it is determined that the user is not viewing the device and is not distracted, and the method continues to block 208 to obtain additional sensor data. In some implementations, if no viewing orientation is detected, the method still continues to block 214 (e.g., the lack of viewing orientation is noted as a factor that can influence further determinations, such as whether to perform block 220). In some implementations, blocks 210 and 212 can be performed in the opposite order from that shown in FIG. 2, or can be performed at least partially simultaneously instead of sequentially.

In block 214, sensor data is obtained from a global positioning sensor of the device. For example, the global positioning sensor can be a sensor that detects signals from the global positioning system (GPS) or other global navigation satellite system (GNSS) to determine a geographical location of the device within a geographical region. Other device positioning techniques, such as beacon-based location determination, wireless triangulation (from cellular towers), determination based on detected Wi-Fi networks, etc. can also be used additionally or alternatively to GPS/GNSS based location determination (the sensor data obtained and used for various positioning techniques are referred to herein as “global positioning sensor data”). In some implementations, a direction, velocity, and/or path of the device is determined, e.g., based on obtaining global positioning sensor data over a time period to determine multiple device locations over that time period. In some implementations, a projected path of the user and device can be determined based on the detected path, e.g., by extending a straight path, continuing a curved path, etc. by a particular distance. Block 214 may be followed by block 216.

In block 216, it is determined whether the global positioning sensor data that was obtained in block 214 indicates foot locomotion of the user. Such foot locomotion can include, for example, walking, jogging, running, etc., or other movement that is not provided by a vehicle (car, motorcycle, bicycle, etc.). In some implementations, the type of locomotion can be determined by detecting the speed of the device and user, where any speeds under a particular threshold speed are determined as foot locomotion and speeds over that threshold are determined as non-foot locomotion (e.g., vehicle locomotion). In some implementations, movement of the device and user provided by a slow moving vehicle (e.g., a golf cart, an assistive vehicle such as a wheelchair, etc.) can be detected as “foot locomotion.”

If the global positioning sensor data indicates the movement of the device and user is by foot, the method continues to block 218. Otherwise, it is determined that the device is moving by vehicle which is not appropriate for the detection methods described herein, and the method continues to block 208 to obtain additional sensor data.

In block 218, it is determined whether the device currently is at a battery power level that is above a threshold power level. The threshold power level can be a power level that is sufficient to allow activation of one or more cameras (e.g., front camera, rear camera, etc.) of the device without causing the battery power level to reduce to a critically low level. For example, the threshold power level can be a predetermined power level that may be configurable by the user in settings of the device. In some implementations, block 218 can be omitted and block 220 performed after block 216 instead. In some implementations, block 218 can be omitted and block 224 performed directly after block 216.

If the device battery power level is above the threshold power level, the method continues to block 220, else the method continues to block 224, described below.

In block 220, one or more images are captured using a front camera of the device and the user's gaze direction is detected. The front camera faces the user and can capture images of the user's face. Based on one or more images showing the user's eyes, a gaze direction of the user is determined using any of various gaze detection techniques. For example, facial landmarks of the user's face can be detected in captured images to determine the location of the user's eyes, and the eye gaze direction can be determined by comparing the user's pupil positions in the images to known positions indicating a gaze at the display screen. In some implementations, an on-device machine learning model trained for gaze detection can be used. Block 220 may be followed by block 222.

In block 222, it is determined whether the user is viewing the display screen of the device. This is determined based on the direction of the user's gaze detected in block 220. If the user is determined to be viewing the device display screen, then the user may be distracted, and the method continues to block 224. Otherwise, it is determined that the user is not distracted by the device and is viewing, at least part of the time, the surroundings and path of travel of the user, and thus does not need hazard detection by the device. Thus, the method continues to block 208 to obtain additional sensor data. In some implementations, the front camera can capture several images over a particular time period to provide accurate gaze detection, e.g., to determine whether the gaze is directed to the device display more than a threshold percentage of time within that time period, which can indicate distraction of the user.

In block 224, an area map is processed for potential hazards to the user within a threshold distance of the device and/or within a threshold angle of the user's projected path. The area map can be a map of an area surrounding the user and device, that includes details of various geographical features, such as streets, buildings, terrain features, etc. in that area. For example, a navigation application available on the device can provide the area map, which can be a portion of a map that the application displays to show the current location of the device based on global positioning sensor data. Other sources can alternatively be accessed to obtain the area map. In some implementations, the area map is retrieved from a server that is in network communication with the device. Some examples of an area map are described below with reference to FIG. 3.

The user's current location on the area map can be determined based on the global positioning sensor data obtained in block 214 and/or obtained at other times. In some implementations, e.g., if the threshold angle of the user's path is being determined, the user's projected path can be imposed on the area map based on multiple detected locations of the user over time based on the global positioning sensor data. In some implementations, the user's velocity of travel (e.g., determined in block 214/216 or in block 224 based on detected user locations over time) can be used to estimate the amount of time before a user intersects or collides with a potential hazard that is located on the user's projected path. In some implementations, the determined location, projected path, and/or velocity of the user can be associated with a confidence score that indicates the amount of confidence in the accuracy of the determined parameters, which can depend on the accuracy of the global positioning sensor data. In some implementations, the confidence scores can be used to determine the threshold distance and/or threshold angle.

The area map includes various geographical features, and some of these features can be categorized as potential hazards to distracted pedestrians. For example, features categorized as potentially hazardous can include: a construction zone due to unlevel ground, barriers, equipment, etc. located in the zone; buildings due to high density of other walking people, stairs or escalators, closed doors, etc.; retail areas due to various objects which a distracted walking user can collide with, such as pillars, signs, garbage cans, curbs, etc.; parks due to objects such as trees, benches, etc.; streets due to moving vehicles, curbs with sudden elevation changes up or down, potholes, lightpoles and fire hydrants on adjacent sidewalks, etc.; driveways to parking lots due to intersecting sidewalks and use by vehicles; areas with varied elevations or unlevel ground; and so on. The device can detect these potential hazards in the area map based on any of various techniques, e.g., finding particular labels of map features, finding particular shapes, etc. For example, in some map applications, area maps may have routes, stairs, construction zones, and other features designated and labelled. In some implementations, one or more machine learning models (e.g., AI application or assistant executing on the device) can be used to detect potential hazards in the area map, which have been trained to detect such features.

A 2D area map or 3D area map can be used in various implementations. In some implementations, a 2D area map can be used (e.g., that includes elevations such as a contour map). In some implementations, a 3D area map can be used that indicates elevations, heights of structures and objects, etc. in the area. In some implementations, the area map may be associated with images of views of the area captured from the perspective of a vehicle or pedestrian in the area, and such images can also be searched for potential hazards using image recognition techniques.

Some potential hazards may be temporary and may be updated on the map by a server that receives updates from users or other sources that report current geographical conditions. For example, a construction zone may be temporary and is removed when construction is completed, or fallen trees in an area may be potentially hazardous but are removed after a time. An area that has numerous people walking or standing, such as a shopping mall area, crowded park or paved pathway, retail area with lots of lines, etc., can be considered potentially hazardous. In some implementations, if some areas are known to be crowded at particular hours (e.g., business hours, or at times of particular events), then those areas can be categorized as potentially hazardous at those times, and categorized as not potentially hazardous (for use in method 200) at other times.

In some implementations, potential hazards on the area map are identified if they are within a threshold distance of the current location of the user. In some implementations, the potential hazards are identified if they are within a threshold angle of the predicted path of the user. The threshold distance can be a distance from the device to the hazard; for example, the distance from the device to a point on the projected path of the user at the threshold distance. For example, the threshold distance can be 15 meters or less in some example implementations, or a different distance. In some implementations, the threshold distance can be variable, e.g., can be set based on an accuracy of the global positioning sensor data from which the geographical location of the device is determined, and/or based on the accuracy of features designated in the area map. For example, if the sensor data has low accuracy, the threshold distance can be larger than if the sensor data has high accuracy. In some implementations, the threshold distance can vary based on one or more characteristics of the user or the environment. For example, the threshold distance can vary based on the user's current velocity, e.g., where larger threshold distances are used for higher velocities. In some implementations, the threshold distance can be based on environmental conditions; e.g., a larger threshold distance can be used in an environment having decreased visibility, such as rain, snow, low light or darkness, etc.

The threshold angle can be an angle that takes into account normal deviations to the direction and projected path that the user is predicted to follow. For example, a threshold angle of 10 or 20 degrees can be used in some implementations, or other angles. In some implementations, the threshold angle can be variable similarly as described above for the threshold distance, e.g., based on accuracy of global positioning sensor data, accuracy of area map features, user, device, or environmental characteristics, etc. In some implementations, hazards located at the threshold distance are determined without considering the threshold angle, e.g., on all sides of the user at the threshold distance. In some implementations, the user can configure the device to use the threshold angle, or not, in determining hazards. Block 224 may be followed by block 226.

In block 226, it is determined whether one or more potential hazards have been detected in block 224 that are within the threshold distance of the device and/or within the threshold angle of the user's projected path. Potential hazards that are outside the threshold distance and threshold angle can be ignored in block 226. In some implementations, it is determined whether one or more potential hazards are within the threshold distance, without considering threshold angle. If one or more potential hazards with these conditions have been detected, the method continues to block 228. In some implementations, the method continues to block 228 if one or more potential hazards are detected with an overall confidence score that is greater than a threshold.

If no such potential hazards are detected in block 226 (or such potential hazards are detected with a confidence score lower than the threshold), in some implementations the method can continue to block 208 to obtain additional sensor data. In some implementations, if no potential hazards are detected in block 226, the method can return to block 224 to continue to process the area map based on updated user locations (e.g., by receiving updated or additional global positioning sensor data as in block 214 that indicates updated geographical locations of the device). In some implementations, the method can continue to return to block 224 from a negative result of block 226 until one or more conditions are detected that cause the method to return to block 208. For example, such conditions can include a particular amount of time expiring with no potential hazards detected, a negative determination of block 226 having a higher confidence level (e.g., an overall confidence score above a threshold), the user entering a safe area indicated on the map, etc.

In block 228, a rear camera hazard detection mode of the device is activated. This mode can be provided by an application (e.g., a hazard detection application) or other software on the device. In this mode, the device turns on and activates the rear camera of the device to capture images over time, e.g., as the user is walking or performing other activity. In some implementations, a rear camera with a wide-angle lens is activated (if available), to obtain a large field of view. The images are processed by the device using object detection and recognition techniques. For example, the application can detect particular types of objects or features in the scene captured in the images, such as people, stairs, fences, benches, signposts, or any of other various objects, some of which may be considered “hazard objects” that are potential hazards to distracted or vision-impaired walking users.

In some implementations, one or more machine learning model(s) trained to detect particular types of objects in images can be implemented on-device. In some implementations, the machine learning models can include neural networks, convolutional neural networks (CNNs), classification models, any of various object detection architectures and models, etc. Machine learning models can run on the device and/or on server(s) in communication with the device. Other image object recognition techniques can also or alternatively be used.

In some implementations, the device in hazard detection mode can estimate distances from the device to objects depicted in the images. In some implementations, distance estimation can be performed based on sensor data from one or more sensors of the device that can be used to sense depth, e.g., a Light Detection and Ranging (LiDAR) sensor, radar sensor, etc. In some implementations, the distance to the object can be estimated based on sizes of objects detected in the captured images. In some implementations, the device in hazard detection mode can estimate angles from a path direction at which detected objects are positioned, such as 10 degrees from the path direction, etc. In some implementations, an angle of a detected object can be estimated by the hazard detection mode on the device based on the distance of the object to the device and the distance within the image that the object is positioned from an estimated travel vector of the user that can be imposed on the images. In some implementations, the device can estimate a trajectory and/or velocity of a moving object detected in the images and determine if such an object may potentially collide with the user based on velocities and trajectories of the user and the object.

In some implementations, the device in hazard detection mode causes the captured images to be displayed on a display device of the mobile device, e.g., in real time as the images are being captured. In various implementations, the images can be displayed in a small size in a portion of a display screen of the device, or can be displayed full size over the entire display screen or a large portion of the display screen. In some implementations, descriptive information is displayed on the displayed images that is associated with objects visible in the images. For example, the descriptive information can include a label of an object, a degree of confidence that the object has been recognized correctly, and/or the distance that the object is currently positioned in front of the user. Block 228 may be followed by block 230.

In block 230, it is determined whether any hazard objects have been detected, e.g., objects that are within a particular distance of the device and/or within a particular angle of the user's path have been detected in block 228 by the device in hazard detection mode using the rear camera of the device. Objects within the particular distance and/or particular angle are considered to be sufficiently potentially hazardous for the user that an alert to the user is warranted. In some implementations, it is determined whether any objects that are within the particular distance of the device have been detected as hazard objects in block 228, without considering a threshold angle. In some implementations, the user can configure the device to use the particular angle, or not, in determining hazard objects.

In some implementations, the particular distance used in blocks 228 and 230 can be a different magnitude than the threshold distance used in map object detection of blocks 224-226. For example, the threshold distance of blocks 224-226 can be a larger distance since it is a condition for turning on the rear camera, while the particular distance of block 230 is a condition for alerting the user of potential hazards. In some implementations, the particular distance and the threshold distance can be the same magnitude. Similarly, in some implementations, the particular angle used in blocks 228 and 230 can be different than the threshold angle used in blocks 224-226 (e.g., the threshold angle can be wider than the particular angle), or in some implementations these angles can be the same magnitude.

In some implementations, the particular distance and/or particular angle checked in block 230 can be variable based on one or more characteristics of the device, the user, the environment in which the user is walking, etc. or multiple of these. For example, the particular distance and/or angle can be larger in conditions of poor visibility, such as rain, darkness, etc. In some implementations, the particular distance and/or the particular angle can be user-configurable, e.g., via device settings or application settings. For example, a vision-impaired user may configure these parameters in way to cause alerts to be provided more easily and often than for a user having unimpaired vision.

If one or more objects are detected in captured images to be within the particular distance and the particular angle, the method continues to block 232 (or, in cases not using threshold angle, within the particular distance). In some implementations, the method continues to block 232 if one or more objects are detected with an overall confidence score that is greater than a threshold. If no such hazard objects are detected in block 230 (or such hazard objects are detected with a confidence score lower than the threshold), the method continues to block 236.

In block 232, an alert is output by the device that indicates a potential hazard in the user's path as detected in block 230. The alert can include one or more of various forms of output from the device, such as an audio signal (e.g., audible alarm or beep), visual output (e.g., a text and/or graphical warning or screen prompt displayed on the display screen of the device, and/or screen blocking of other apps executing on the device), haptic output (e.g., a vibration output on the housing of the device), etc. Block 232 may be followed by block 234.

In block 234, the hazard detection mode is maintained in an active state and the rear camera is continued to be powered. For example, the device in hazard detection mode can continue to monitor the objects previously detected in block 230 and can determine whether other objects have become hazard objects. Block 234 may be followed by block 230 to determine whether one or more objects are within the particular distance and angle.

In block 236, the hazard detection mode is deactivated, causing the rear camera of the device to be deactivated, e.g., to conserve battery power. Block 236 may be followed by block 208 to obtain sensor data from the motion sensors and determine the conditions of the blocks of method 200.

In some implementations, if one or more hazard objects were previously detected in hazard detection mode before a lack of detection of hazard objects in block 230, e.g., within a predetermined time period before the lack of detection, then block 234 can be performed instead of block 236 to maintain hazard detection mode, e.g., for a particular amount of time. If hazard objects are not detected after the particular amount of time, block 236 is performed.

In some implementations, if a lack of detection of hazard objects in block 230 (and/or in block 224) is based on a detection process having low confidence (e.g., providing a confidence score below a threshold), then hazard detection mode can be maintained at block 234 (e.g., without providing an alert) instead of being deactivated in block 236 until a higher confidence result (e.g., above the threshold) is determined.

Thus, method 200 provides several conditions that are tested before a rear camera of the device is activated, thus enabling selective activation of the rear camera. In some cases, if one or more conditions are not satisfied, the user is not considered to be in danger from potential hazards in the environment, and the rear camera is not activated, thus saving power consumption compared to keeping the rear camera powered continuously.

In some implementations, the blocks of method 200 can be performed in an order other than the order shown in FIG. 2. In some implementations, some blocks of method 200 can be performed at least partially simultaneously. In some implementations, one or more blocks of method 200 can be omitted, and this may be user-configurable in some implementations. For example, a vision-impaired user may omit the conditions of blocks 210, 212, 216, 218, 222, and/or 224-226 and activate the rear camera hazard detection mode in block 228 without checking for one or more of these conditions.

In various implementations, various blocks of method 200 may be combined, split into multiple blocks, performed in parallel, or performed asynchronously. In some implementations, one or more blocks of method 200 may not be performed or may be performed in a different order than shown in FIG. 2. Method 200, or portions thereof, may be repeated any number of times using additional inputs.

In some implementations, one or more of the conditions determined in method 200 can be determined with a respective associated score that indicates the degree to which the condition has been met. In some implementations, hazard detection in method 200 can be based on the scores of multiple conditions determined in method 200. For example, one or more of the conditions determined in blocks 210, 212, 216, 222, 226, and/or 230 can cause a respective individual score to be determined. For example, detection of movement in block 210 can be associated with a score based on how close the detected movement of the device is to walking movement (e.g., based on comparing the detected motion data to walking data profiles, etc.). Detection of the device oriented at an angle as determined in block 212 can be associated with an individual score based on how close the device angle is to the viewing angle range. Detection of a potential hazard in blocks 224 and 226 can be associated with a score based on the distance of the closest detected hazard to the projected path of the user and/or based on the accuracy of global positioning sensor data.

In some implementations, a particular percentage of the individual scores can meet respective thresholds to indicate that a hazard object has been detected. Alternatively, an overall score that is a combination of the individual scores can meet an overall threshold to indicate that a hazard object has been detected. In some implementations, individual scores from blocks 210, 212, 216, 222, and 226 can be combined (e.g., summed) to obtain the overall score, and the overall score can be compared to a threshold to determine whether to activate the rear camera hazard detection mode in block 228. In some implementations, individual scores from blocks 210, 212, 216, 222, 226, and/or 230 can be combined (e.g., summed) to obtain an overall alert score, and the overall alert score can be compared to a threshold to determine whether to output an alert as in block 232. In some implementations, scores from one or more particular conditions can be weighted differently in the overall score than scores from other conditions, e.g., depending on how much a condition is considered to reliably indicate a hazard object in a path of the user.

FIG. 3 is a diagrammatic representation of an example area map 300 that can be used in methods described herein to detect potential hazards to a walking user, according to some implementations. Area map 300 can be a portion of a geographical map of the area or region in which the user and device are located. For example, area map 300 can be provided from map data that is accessible to the device via a digital map or navigation application, atlas application, or other application available on the device. In some implementations, the map data is stored locally on the device or may be retrieved from a server or other device over a network such as a wireless network.

In the example of FIG. 3, various landscape features are shown in area map 300. These features include streets, various buildings, a park, construction zones, etc. The current location of the user is indicated by a user pointer 302, which is placed on map 300 at a location based on global positioning sensor data. The user location is updated and moved to new locations on map 300 in real time as additional sensor data is retrieved that indicates the user's updated current location. In addition, a projected path 304 of the user is estimated based on the direction of travel of the user as indicated by previous locations of the user. In this example, since the direction that the user is likely to travel after arriving at street 306 is not known (e.g., north, east, etc.), the projected path 304 terminates at street 306. In other cases, the device may have access to a destination of the user, e.g., based on the user having input the destination in a navigation application, calendar, or other application (and having permitted access to this information), and the projected path can be extended to that destination.

If device conditions (determined in method 200) indicate that the user is walking and/or is viewing the device, the device searches the area map 300 for potential hazards in the user's projected path. In this example, a construction zone 310 is detected directly in the path of the user, which is categorized as a potential hazard. The device determines that zone 310 is located within a threshold distance of the user's location and is located within a threshold angle of projected path 304 (e.g., straight ahead of the user), and so the rear camera hazard detection mode is activated on the device to power the rear camera and capture images in front of the user.

The projected path of the user may intersect other features of map 300 that may be categorized as potential hazards. For example, street 306 may be a potential hazard with its near curb being within the threshold distance and angle of the user. Buildings 312 can be determined to be potential hazards if the user's projected path intersects them. Driveways 314 can be categorized as potential hazards due to changes in elevation or slope and/or vehicles that may cross a path of the user at these locations. Features within park 316 can be categorized as potential hazards, such as trees 318, bench 320, building 322, etc.

In some implementations, area map 300 or a similar representation can be displayed on a display screen of the device, e.g., to inform the user of potential hazards in the area. Detected potential hazards can be highlighted in the displayed map (e.g., displayed in bright colors, flashing colors, etc.).

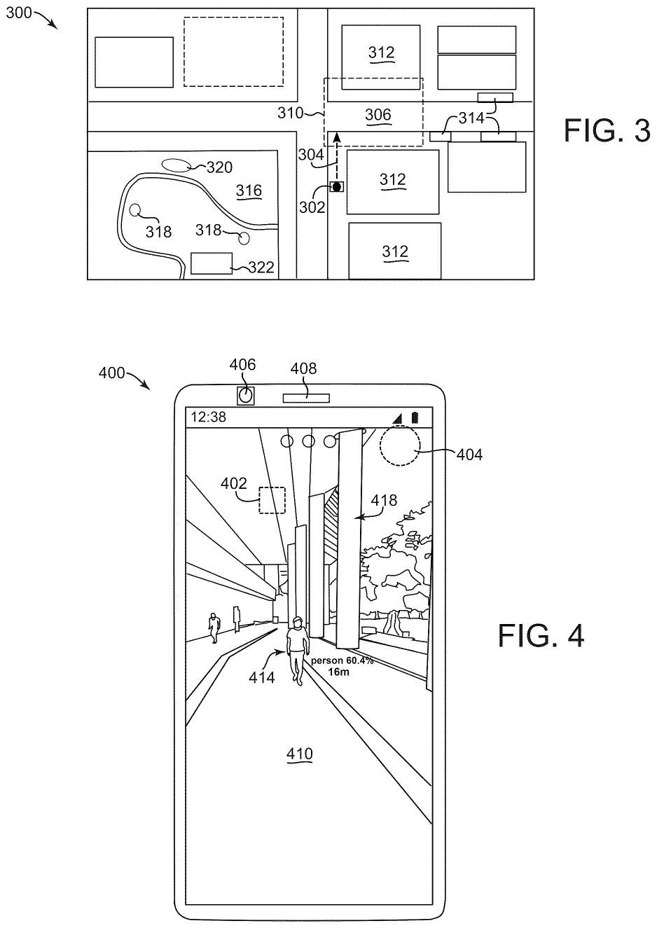

FIG. 4 illustrates a front view of a device 400 that can be used with hazard detection features described herein, according to some implementations. Device 400 can be, for example, a mobile device such as a cell phone, smartphone, tablet, wearable device (e.g., display in glasses or goggles, wristwatch, headset, wristband, armband, jewelry, etc.), personal digital assistant (PDA), media player, portable game device, device embedded in a vehicle, etc. Device 400 can be held (or worn) and carried by the user and operated in any location.

Device 400 can include several sensors that can be used in the methods described herein. For example, an inertial measurement unit (IMU) 402 (located within the housing of device 400) can include one or more of accelerometer(s), gyroscope(s), and/or magnetometer(s), and can measure acceleration, angular rate, orientation, gravitational forces, etc. and thus sense motion of the device 400, e.g., when it is picked up by a person, taken out of a pocket, carried while a person is moving (e.g., walking or riding in a vehicle), etc.

The device sensors include a rear camera 404 that is located on the rear side of device 400 (opposite to the shown front side). The rear camera can capture images of scenes in its field of view that is in front of the user who is operating device 400 from the front side. The device sensors also may include a front camera 406, which can capture images of scenes in its field of view that faces the user, e.g., a face of the user operating and facing the device 400, if user consent has been obtained. Other sensors can also be included in device 400. In various implementations, the various sensors and other components described above can be positioned in locations of device 400 other than those shown in FIG. 4.

Device 400 may include a speaker 408 that outputs sound waves as audio, including audio alerts output by the device as described herein. One or more other input and output devices can also be provided on device 400, e.g., additional audio speakers, microphones, physical buttons, trackpads, etc. Device 400 can communicate wirelessly with one or more other devices, base stations, etc. using components such as a radio, antennas, etc.

Device 400 includes a touchscreen 410 that displays various information and can receive input from the user via touch, e.g., gestures such as taps, swipes, etc. on the surface of the touchscreen by one or more fingers. Touchscreen 410 can be implemented as any of a variety of types of touchscreens (e.g., capacitive sensing of touch, pressure sensing of touch, etc.).

Touchscreen 410 can be used, in some implementations or modes, to display information associated with the hazard detection techniques described herein. In some implementations, touchscreen 410 can display current conditions of device 400 related to hazard detection techniques. For example, a current orientation of the device and/or an area map used for detecting hazards around the user can be displayed by touchscreen 410, e.g., on the entire display area or in a portion of the display area of touchscreen 410 (e.g., in a window in a corner or side of touchscreen 410).

In the example shown in FIG. 4, touchscreen 410 displays images captured by rear camera 404. A rear camera hazard detection mode has been activated on device 400 to cause the rear camera to be turned on, after particular conditions of the device have been detected such as the user is walking and viewing the touchscreen, and a hazard has been detected in the user's path based on an area map for the location of the user. Although shown as a full screen display in FIG. 4, the images captured by the rear camera can be shown in a smaller size, e.g., in a portion of touchscreen 410.

In this example, touchscreen 410 shows an image captured by the rear camera 404 that shows a portion of a scene in front of the user who is walking. The user is holding the device 400 at a viewing angle, which allows rear camera 404 to capture a scene in front of the user. In this example, the device 400 displays additional information related to detected potential hazard objects in the user's path. For example, person 414 has been detected as a hazard object. In some implementations, person 414 can be highlighted on touchscreen 410 to be visually emphasized, e.g., displayed in a contrasting color to the background or with flashing colors. The device has determined a descriptive label of person 414 (“person”) based on image/video recognition techniques and has determined the distance from device 400 to person 414 and displayed that distance (“16 m”). In some implementations, the device can also display a confidence score (e.g., as a percentage) that the detected object has been recognized accurately. Other hazard objects can also be labelled in the displayed view. For example, column 418 can be highlighted and labelled as a hazard object.

In some implementations or modes, the view of the rear camera is not displayed on touchscreen 410. For example, the user can interface with a different application having a displayed user interface while rear camera hazard detection mode is operating in the background to capture images from the rear camera and detect objects in the captured images.

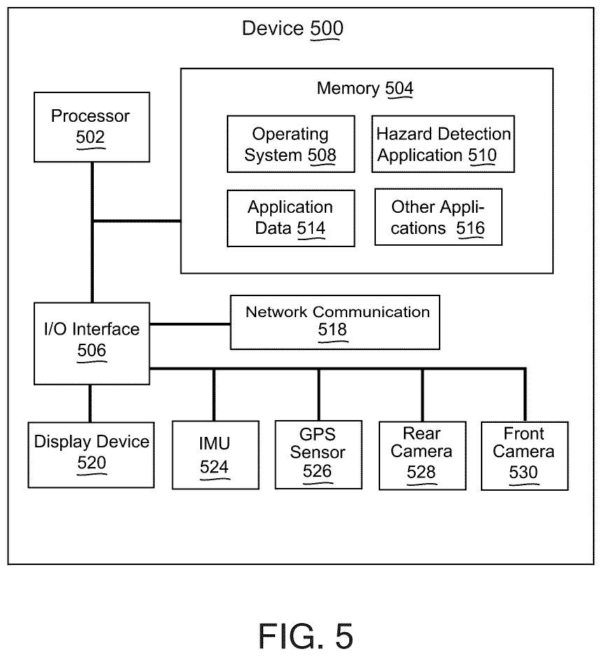

FIG. 5 is a block diagram of an example device 500 which may be used to implement one or more features described herein. In some examples, device 500 may be used to implement a client device, e.g., a mobile device 400 shown in FIG. 4, or any mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc. Alternatively, device 500 can implement a different type of device, e.g., server device, desktop computer device, etc. that can be used to provide one or more implementations described herein or portions thereof. Device 500 can be any suitable computer system, server, or other electronic or hardware device as described above.

Features described herein can operate in several environments and platforms. In some implementations, all operations can be performed within a mobile device. In some implementations, with user consent, a client/server architecture can be used, e.g., a mobile device (as a client device) sends data to a server device (e.g., sensor data such as motion data, device angle, user location and captured images) and receives data from the server (e.g., indications and locations of hazards and hazard objects detected by the server, indication of movement type, confidence scores, location of user eye gaze, etc.) to be used in operations by the client device. In another example, operations can be split between the mobile device and one or more server devices.

In some implementations, device 500 includes a processor 502, a memory 504, and input/output (I/O) interface 506. Processor 502 can be one or more processors and/or processing circuits to execute program code and control basic operations of the device 500. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some implementations, processor 502 may include one or more co-processors that implement neural-network processing. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems.

Memory 504 is provided in device 500 for access by the processor 502, and may be any suitable processor-readable storage medium, such as random access memory (RAM), read-only memory (ROM), Electrical Erasable Read-only Memory (EEPROM), Flash memory, etc., suitable for storing instructions for execution by the processor, and located separate from processor 502 and/or integrated therewith. Memory 504 can store software operating on device 500 by processor 502, including an operating system 508, a hazard detection application 510, other applications 512, and application data 514. In some implementations, hazard detection application 510 can perform hazard detection features and methods as described herein. Application 510 can include instructions that enable processor 502 to perform functions described herein, e.g., some or all of blocks of method 200 of FIG. 2. In some implementations, machine learning models used by features of method 200 can be stored in memory 504 and/or in other accessible storage. In some implementations, data used in hazard detection operations can be stored as application data 514 or other data in memory 504, and/or on other storage devices of one or more other devices in communication with device 500. Other applications 512 may include applications such as navigation and map applications, AI applications, communications application, data display engine, image editing applications, notification engine, social networking engine, media display applications, web hosting engines or applications, media sharing applications, etc.

Any of software in memory 504 can alternatively be stored on any other suitable storage location or computer-readable medium. Memory 504 and any other type of storage (magnetic disk, optical disk, magnetic tape, or other tangible media) can be considered “storage”or “storage devices.”

I/O interface 506 can provide functions to enable interfacing processor 502 and memory 504 with other components of device 500 and with other devices. Interfaced devices can be included as part of the device 500 or can be separate and communicate with the device 500. For example, network communication devices, storage devices (e.g., memory and/or database), and input/output devices can communicate via I/O interface 506. In some implementations, the I/O interface can connect to interface devices such as input devices (keyboard, pointing device, touchscreen, microphone, camera, scanner, sensors, etc.) and/or output devices (display devices, speaker devices, printers, motors, etc.). In some implementations, hardware used for components of device 400 of FIG. 4 can be included in I/O interface or other connected components of device 500.

Some examples of interfaced devices that can connect to I/O interface 506 can include a network communication device 518. Device 518 can connect device 500 to a communication network environment that can include one or more server devices and/or one or more client devices which may communicate with each other and device 500 via the network. The network can be any type of communication network, including one or more of the Internet, local area networks (LAN), wireless networks, switch or hub connections, etc. In some implementations, the network can include peer-to-peer communication between devices, e.g., using peer-to-peer wireless protocols (e.g., Bluetooth®, Wi-Fi Direct, etc.), etc.

The devices connected to I/O interface 506 can also include one or more display devices 520 that can be used to display content, e.g., images, video, and/or a user interface of an application. Display device 520 can be connected to components of device 500 via local connections (e.g., display bus) and/or via networked connections and can be any suitable display device, e.g., a touchscreen as described in FIG. 4, e.g., an LCD, LED, or plasma display screen, CRT, television, monitor, 5-D display screen, or other visual display device. Display device 520 may also act as an input device, e.g., a touchscreen input device such as a flat display screen provided on a mobile device, multiple display screens provided in glasses or a headset device, a monitor screen for a computer device, motors or other actuators for outputting vibration on the device, etc.

Other interfaced devices can include an IMU 524, GPS sensor 526, rear camera 528, and front camera 530 that can be implemented as described herein. For example, sensor data can be sent from sensors 524-530 to processor 502 and memory 504 for processing and storage. The I/O interface 506 can interface to other input and output devices (not shown). Some examples include one or more microphones for capturing sound such as speech or other sounds emitted from a user, a radar or other sensors for detecting gestures, audio speaker devices for outputting sound, etc.

Any of software in memory 504 can alternatively be stored on any other suitable storage location or computer-readable medium. Memory 504 and any other type of storage (magnetic disk, optical disk, magnetic tape, or other tangible media) can be considered “storage” or “storage devices.”

For ease of illustration, FIG. 5 shows one block for each of processor 502, memory 504, I/O interface 506, software blocks 508-516, sensors, etc. These blocks may represent one or more processors or processing circuitries, operating systems, memories, I/O interfaces, applications, devices, components, and/or modules. In other implementations, device 500 may not have all of the components shown and/or may have other elements including other types of elements instead of, or in addition to, those shown herein. While some components are described as performing blocks and operations as described in some implementations herein, any suitable component or combination of components, similar devices, or any suitable processor or processors associated with such a device, may perform the blocks and operations described.

Methods described herein, or portions thereof, can be implemented by computer program instructions or code, which can be executed on a computer. For example, the code can be implemented by one or more digital processors described herein (e.g., microprocessors or other processing circuitry) and can be stored on a computer program product including a non-transitory computer-readable medium (e.g., storage medium), such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively or additionally, one or more methods or portions thereof can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and an operating system.

Further to the descriptions herein, a user may be provided with controls allowing the user to make an election as to both if and when systems, programs, or features described herein may enable collection of user information (e.g., information about a user's activities, preferences, locations, captured images, messages, social actions, a user's device, etc.), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement operations of particular implementations. Different programming techniques may be employed, e.g., procedural or object-oriented. The operations may execute on a single processing device or multiple processors. Although steps, operations, or computations may be presented in a specific order, the order may be changed in different particular implementations and/or multiple operations shown as sequential in this specification may be performed at the same time.

1. A computer-implemented method comprising:
obtaining, by at least one processor, sensor data from one or more sensors of a device, wherein the sensor data includes global positioning sensor data;
determining, by the at least one processor based on the sensor data, geographic locations of the device;
obtaining map data that describes features of a geographical area in which the device is located;
determining, by the at least one processor based on the map data and the geographic locations of the device, whether one or more potential hazards are within a threshold distance of the device;
in response to determining that the one or more potential hazards are within the threshold distance to the device, activating, by the at least one processor, a rear camera of the device;
capturing images, by the at least one processor, using the activated rear camera of the device;
determining, by the at least one processor, whether one or more hazard objects are positioned within a particular distance of the device based on the images captured by the rear camera; and
outputting, by the least one processor, an alert in response to determining that the one or more hazard objects are within the particular distance of the device.

2. The computer-implemented method of claim 1, wherein the threshold distance is based on an accuracy of the global positioning sensor data in determining the geographical locations of the device.

3. The computer-implemented method of claim 1, wherein the threshold distance is based on one or more characteristics of an environment in which the device is located.

4. The computer-implemented method of claim 1, further comprising:
determining, based on the sensor data, a projected path of the device through a geographical region; and
determining, by the at least one processor based on the map data and the geographic locations of the device, whether the one or more potential hazards are within a threshold angular range of the projected path,
wherein activating the rear camera of the device is performed in response to determining that the one or more potential hazards are within the threshold distance to the device and within the threshold angular range of the projected path of the device.

5. The computer-implemented method of claim 1, wherein in response to determining that the one or more potential hazards are not within the threshold distance to the device:
omitting the activating of the rear camera of the device at a current geographical location of the mobile device;
obtaining additional sensor data that describes an updated geographical location of the device;
determining, by the at least one processor based on the map data and at least the additional sensor data, whether at least one potential hazard is within the threshold distance of the device; and
in response to determining that the at least one potential hazard is within the threshold distance to the device, performing the activating the rear camera of the device, the capturing the images, the determining whether one or more hazard objects are positioned within the particular distance of the device, and the outputting the alert.

6. The computer-implemented method of claim 1, further comprising:
determining, by the at least one processor based on the sensor data, a projected path of the device through a geographical region; and
determining, by the at least one processor, whether the one or more hazard objects are positioned within a particular angular range of the projected path of the device.

7. The computer-implemented method of claim 1, further comprising causing the images captured by the rear camera to be displayed on a display screen of the device and causing highlighting of the one or more hazard objects in the displayed images.

8. The computer-implemented method of claim 1, further comprising determining, by the at least one processor based at least on the sensor data, whether the device is being moved by a user using foot locomotion,
wherein obtaining the map data and determining that the one or more potential hazards are within the threshold distance to the device is performed in response to determining that the device is being moved by the user using foot locomotion.

9. The computer-implemented method of claim 8, wherein the sensor data includes motion data sensed by at least one motion sensor of the one or more sensors of the device, and wherein determining, by the at least one processor based at least on the sensor data, whether the device is being moved by the user using foot locomotion comprises:
determining, by the at least one processor based on the motion data, whether the device is being moved by the user via foot locomotion; and
determining, by the at least one processor based on the global positioning sensor data, whether the device is being moved at less than a threshold velocity that indicates the foot locomotion.

10. The computer-implemented method of claim 8, wherein in response to determining that the device is not being moved by the user using foot locomotion:
omitting the activating of the rear camera of the device.

11. The computer-implemented method of claim 1, wherein the sensor data includes motion data sensed by at least one motion sensor of the one or more sensors of the device, and further comprising:
determining, by the at least one processor based on the motion data, whether an orientation of the device is within a threshold angular range corresponding to a viewing orientation of the device for a user,
wherein obtaining the map data and determining that the one or more potential hazards are within the threshold distance to the device is performed in response to determining that the orientation of the device is within the threshold angular range.

12. The computer-implemented method of claim 1, further comprising:
activating, by the at least one processor, a front camera of the device; and
detecting, by the at least one processor, features in one or more images captured by the activated front camera to determine whether a user's gaze is directed to a display screen of the device,
wherein obtaining the map data and determining that the one or more potential hazards are within the threshold distance to the device is performed in response to determining that the user's gaze is directed to the display screen of the device.

13. The computer-implemented method of claim 12, further comprising:
determining, by the at least one processor, whether a battery level of the device is above a threshold power level,
wherein activating the front camera of the device is performed in response to determining that the battery level is above the threshold power level.

14. A mobile device comprising:
at least one processor;
one or more global positioning sensors coupled to the at least one processor, wherein the one or more global positioning sensors are operative to provide global positioning sensor data to the at least one processor; and
a rear camera coupled to the at least one processor,
wherein the at least one processor is configured to perform operations comprising:
obtaining the global positioning sensor data from the one or more global positioning sensors;
determining, based on the global positioning sensor data, geographic locations of the mobile device;
obtaining map data that describes features of a geographical area in which the mobile device is located;
determining, based on the map data and the geographic locations of the mobile device, whether one or more potential hazards are within a threshold distance of the mobile device;
in response to determining that the one or more potential hazards are within the threshold distance to the mobile device, activating the rear camera;
capturing images using the activated rear camera of the mobile device;
determining whether one or more hazard objects are positioned within a particular distance of the mobile device based on the images captured by the rear camera; and
outputting an alert in response to determining that the one or more hazard objects are within the particular distance of the mobile device.

15. The mobile device of claim 14, wherein the threshold distance is based on at least one of:
an accuracy of the global positioning sensor data in determining the geographical locations of the mobile device; or
one or more characteristics of an environment in which the mobile device is located.

16. The mobile device of claim 14, wherein in response to determining that the one or more potential hazards are not within the threshold distance to the mobile device, the operations further comprise:
omitting the activating of the rear camera of the mobile device at a current geographical location of the mobile device;
obtaining additional sensor data that describes an updated geographical location of the mobile device;
determining, by the at least one processor based on the map data and at least the additional sensor data, whether at least one potential hazard is within the threshold distance of the mobile device; and
in response to determining that the at least one potential hazard is within the threshold distance to the mobile device, performing the activating the rear camera of the mobile device, the capturing the images, the determining whether one or more hazard objects are positioned within the particular distance of the mobile device, and the outputting the alert.

17. The mobile device of claim 14, further comprising one or more motion sensors coupled to the at least one processor and operative to provide motion data to the at least one processor, and wherein the operations further comprise:
determining, based at least on the motion data, whether the mobile device is being moved by a user using foot locomotion,
wherein the operations of obtaining the map data and determining that the one or more potential hazards are within the threshold distance to the mobile device is performed in response to determining that the mobile device is being moved by the user using foot locomotion.

18. The mobile device of claim 17, wherein the operations further comprise:
determining, based on the motion data, whether an orientation of the mobile device is within a threshold angular range corresponding to a viewing orientation of the mobile device for the user,
wherein the operations of obtaining the map data and determining that the one or more potential hazards are within the threshold distance to the mobile device is performed in response to determining that the mobile device is being moved by the user using foot locomotion and determining that the orientation of the device is within the threshold angular range.

19. The mobile device of claim 14, further comprising a front camera coupled to the at least one processor, and wherein the operations further comprise:
in response to determining that an orientation of the mobile device is within a threshold angular range, activating the front camera; and
detecting features in one or more images captured by the activated front camera to determine whether a user's gaze is directed to a display screen of the mobile device,
wherein the operations of obtaining the map data and determining that the one or more potential hazards are within the threshold distance to the mobile device is performed is performed in response to determining that the user's gaze is directed to the display screen of the mobile device.

20. A non-transitory computer-readable medium with instructions stored thereon that, when executed by a processor, cause the processor to perform operations comprising:
obtaining, by at least one processor, sensor data from one or more sensors of a device, wherein the sensor data includes global positioning sensor data;
determining, by the at least one processor based on the sensor data, geographic locations of the device over a period of time;
obtaining map data that describes features of a geographical area in which the device is located;
determining, by the at least one processor based on the map data and the geographic locations of the device, whether one or more potential hazards are within a threshold distance of the device;
in response to determining that the one or more potential hazards are within the threshold distance to the device, activating, by the at least one processor, a rear camera of the device;
capturing images, by the at least one processor, using the activated rear camera of the device;
determining, by the at least one processor, whether one or more hazard objects are positioned within a particular distance of the device based on the images captured by the rear camera; and
outputting, by the least one processor, an alert in response to determining that the one or more hazard objects are within the particular distance of the device.
